(19) United States
(12) Patent Application Publication
(10) Pub. No.: US 2008/0016336 A1
(43) Pub. Date: Jan. 17, 2008

(54) GENERIC PUBLIC KEY INFRASTRUCTURE ARCHITECTURE

(75) Inventors: Vlad Stirbu, Tampere (FI); Seamus Moloney, Riihimaki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/775,794

(22) Filed: Jul. 10, 2007

Related U.S. Application Data
(60) Provisional application No. 60/831,368, filed on Jul. 17, 2006.

(51) Int. Cl. H04L 9/00

(52) U.S. Cl. 713/156

(57) ABSTRACT

Methods, apparatuses and modules for creation of a generic public key infrastructure by use of established trust, wherein trust between a client and a registration authority is established, and an enrolled certificate is furnished in a secure manner to the client by use of the established trust. The present invention also address correspondingly configured servers and/or terminals, client and/or registration authorities and/or certificate authority entities, as well as device security, security-aware control points and security console units, provided with such modules and functions enabling the aspects of the method/s to be carried out. Respective computer programs and circuit arrangements for carrying out the aspects of the methods and/or for operating hardware to carry out the aspects of the above methods are also provided.

### CROSS-REFERENCE TO RELATED PATENT APPLICATIONS

The present application claims priority to U.S. Provisional Patent Application No. 60/831,368, filed Jul. 17, 2006.

### FIELD OF THE INVENTION

The present invention relates to a generic public key (PKI) infrastructure architecture. More particularly, the present invention relates to methods, devices and modules for creation of a generic PKI architecture based on an established security association, such as for use in Universal Plug and Play (UPnP) networks, for example.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The use of consumer electronic (CE) devices is widely spreading in recent years. Examples of such CE devices are for example mobile phones with additional functionalities such as MP3© players and/or FM (frequency modulation) radios and/or (video/still picture) cameras. Other examples comprise such devices without the mobile phone capability and may e.g. reside in a server accessible by LAN (local area network) or WLAN (wireless local area network), Bluetooth™ or any other access technology by (authorized) parties simultaneously or successively in order to share content kept on the server. Sharing content may include downloading (a copy of) such content to a terminal or other device or merely accessing the content from such a terminal. A terminal in this sense may be represented by a mobile phone as a mobile terminal or any other kind of terminal. Similarly, a mobile phone or other terminal may have a server functionality so as to e.g. share pictures at one mobile phone acting as a server with other terminals (e.g. mobile phones). In any case, CE devices may also comprise e.g. (TeleVision) TV sets or any other display equipment such as a computer monitor and/or (High Fidelity) HiFi equipment or any other audio reproducing equipment, or even a personal computer or so-called workstation, or a personal digital assistant PDA. CE devices may be associated (e.g. connected by wire or wirelessly) to a server device and reproduce content kept at the server.

As consumer electronic devices (referred to also as CE devices) become network enabled, home networking scenarios are emerging which allow content to be stored on one device in the home, referred to as server, and to be moved by a second device (acting as a controller or administrating device) to a playing device such as the above mentioned devices e.g. a TV or home HiFi system which may reproduce the content. A mobile phone is seen as an ideal example device to act as the controller in such scenarios.

Mobile devices spend a good deal of their time outside the home, so for a consistent user experience, they should be able to still access and/or control the content stored on the home media servers. Such content should not be allowed to be viewed by just anyone, so control and security of access to the content and a secure tunnel between the mobile device and the home are requirements.

“Universal Plug and Play”, UPnP™, is currently seen as a quite realistic standard for enabling interoperability between home CE devices. In the UPnP Forum, several companies have begun to work on specifying a Remote Access service for controlling the access to the home and this standard is expected to be agreed on by end of 2006.

In general, UPnP technology defines an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP (Transport Control Protocol/Internet Protocol) and web technologies to enable seamless proximity networking in addition to control and data transfer among networked devices. The UPnP Device Architecture (UDA) is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices.

“UPnP security” is a standard which has been in existence since 2003 and is concerned with how to secure UPNP interactions in a LAN environment. Accordingly, UPnP security relates to the creation of security associations between devices for the purpose of authentication of action invocation. For example, basics of such interactions are laid down in “Device Security: 1 Service Template”, and “Security Console: 1 Service Template”, both of Nov. 17, 2003 and for UpnP™ Device Architecture (UDA) 1.0.

In such scenarios, there needs for example to be a way to securely grant access to the home network to any device the home owner wishes to allow. Also, this should be possible while the home owner is at home but also while outside the home, for instance while visiting a friend.

Still further, in the UpnP™ security model as one example of an application scenario for the present invention to be described later, there is an Access Control List (ACL), in which all the users and their permissions are listed. This list is located in the media server. Only the owner of the media server is able to modify the list using activities such as create/update/delete user accounts, give permissions to a user account and associate Control Points (CP) with user accounts. All these modifications require on-line connection between the media server and the owner/server owner's terminal device. A control point CP may be exemplified by a user terminal, also referred to as CP user.

FIG. 1 shows in an overview a media sever associated to two different examples of control points, a security aware (SA CP) and a security unaware control point. Furthermore, actions applicable by a control point user (CP user) are indicated, and actions applicable by an owner (administrator) of the media server are indicated. The internal composition of the media server and the interactions therewith are only roughly outlined and details can be found in the above referenced UPnP™ references.

Another aspect of UPnP security is concerned with a public key infrastructure architecture (PKI). Public Key Infrastructure is a system of digital certificates, certificate authorities and other registration authorities that verify and authenticate the validity of each party involved in an Internet transaction. In this connection, certificates are usually understood as a combination of a public key plus a signature of that key, which is made by a private key of some certificate authority. Currently, PKI's are evolving and there is no single PKI or even a single agreed-upon standard for setting up a PKI. A PKI is also called a trust hierarchy.

The basic idea behind PKI is that each one of involved devices have a pair of keys: a private key and a public key. The keys are not the same but they are paired (which means, for a private key there is only one corresponding public key). The private key should never be revealed to others while public key could be delivered to others. So one could encrypt some data for another party by using their public key. The encrypted data could be decrypted by that party using their private key. Since the private key is never revealed to others, so only those who have the corresponding public key could decrypt the document. In addition to protecting data for transport, public key based cryptography can also be used to guarantee the integrity of transported data. This means that PKI based cryptography works so that if a device (A) has a keypair PubkeyA and PrivkeyA and then gives B the PubkeyA part, A can later digitally sign data with PrivkeyA and give that (signed data) to B. B will be able to verify that the signature was really made by A based only on the PubkeyA device A gave to B earlier, although B has no knowledge of A's private key.

A problem in this regard resides in that UPnP security can be used to limit certain actions on a UPnP device to invocation by only a selected set of UPnP control points. The PKI, which UPnP security can establish, supports this use case alone, but there are many more scenarios where it would be beneficial for a UPnP device to be able to deal with client control points using certificates (in addition to UPnP control points). Examples of this include remote access, enabling of IPSEC (IP security) tunnel creation between the two devices and usage of certificates for secure e-mail or other application level communication between these devices.

Because it would be a bad security practice to re-use the security associations established for UPnP purposes directly in other domains and/or fields of application, a solution is needed which builds on these secure associations to establish other secure associations for other purposes. This needs to be done without requiring new standardization as current standards have taken a very long time to establish, and interoperability is of utmost importance. However, no such solution has been proposed yet.

It should be noted that UpnP™ is used as an example only and the present invention is applicable in its generality to a variety of similar or different systems.

In the scenario according to FIG. 1, the owner of the media server is not always present in the UPnP network and does not always have e.g. an IP access to the media server. In such a situation, the owner is not able to modify the Access Control List ACL. There might, however, be a case that there is some friend or relative visiting the owners home and while the owner is e.g. at work, and such visitor as a control point (CP) user would like to access content, e.g. to watch movies or listen for music from the owners media server, but he/she does not have the access credentials nor the user account to the UPnP™ network at the owner's home UpnP™ network. If the owner does not have access to the server, he/she is not able to give access rights to the visitor.

However, whenever access is granted to a user of a network, in particular to a privately owned network, security issues are of utmost importance. Therefore, UPnP™ security specification defines the basic building blocks for managing the access rights etc, but there is an ongoing activity to improve the UPnP™ security-based solution for a comprehensive set of use cases for UPnP™ Audio Video.

Security considerations comprise e.g. the following aspects:
Remote Access services interface must be protected,
Prevent bad behaving/rogue users to configure Remote Access profiles without owner consent,
Remote Access services interface must not be exposed on e.g. WAN (Wide area network) interface or other interface of the Gateway/server due to likelihood of e.g. internet based attacks,
Remote Access connection authentication must be based on-strong cryptography (mere password based authentication is generally weak to dictionary attacks)
   Remote Access authorizations must be flexible to enable e.g. One-time, “one period” such as one week, or even permanent access, but the server owner must be able to revoke rights at any time, while user interactions needed for setting up security must be minimal.

### SUMMARY OF THE INVENTION

Hence, various embodiments of present invention remove the above drawbacks inherent to the prior art, to improve the pre-existing security scenarios and to enable to create a generic security architecture. This is, for example, accomplished in a method of creating a generic public key infrastructure, comprising establishing trust between a client and a registration authority, securely furnishing an enrolled certificate to the client by use of the established trust. This is also accomplished by a respectively configured client apparatus, registration authority apparatus, generic public key infrastructure architecture, as well as by corresponding computer programs, circuit arrangements, modules or the like.

By virtue of the present invention, as explained in this connection, at least one of the following effects can be achieved:
Remote access according to UPnP (Universal Plug and Play) and/or DLNA (Digital Living Network Alliance) as well as other scenarios and types of (peer-to-peer) communication requiring certificates are supported.
Scalability of the created PKI architecture framework is provided.
Downward compatibility is ensured in that the presented solutions are compliant with existing standards.
A trust hierarchy (public key infrastructure) is achieved by use of an existing trust chain establishment.

An advantageous effect of embodiments of the present invention also resides in that the thus created security infrastructure is applicable to a wide variety of applications. Examples of such applications include, among others, secure remote access (e.g. to a media server), IPSec tunnel creation, secure e-mail, secure communication for IM (Instant Messaging), gaming, VoIP (Voice over IP) or the like; stated in general terms, embodiments of the present invention are applicable to any application or web service running on a secure device.

The present invention also addresses correspondingly configured servers and/or terminals, client and/or registration authorities and/or certificate authority entities, as well as device security, security-aware control points and security console units, provided with such modules and functions enabling the aspects of the method/s to be carried out. Respective computer programs and circuit arrangements for carrying out the aspects of the methods and/or for operating hardware to carry out the aspects of the above methods are also provided.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The present invention is described herein below with reference to the drawings.

FIG. 1 shows in an overview a media sever associated to two different examples of control points together with actions applicable by a control point user and actions applicable by an owner of the media server;

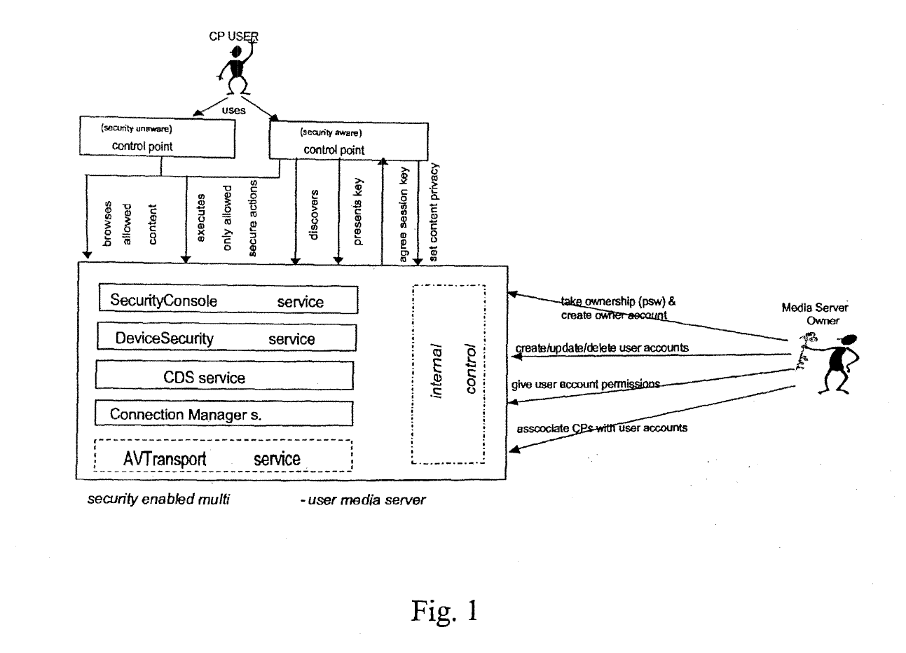

FIG. 2 is a schematic overview of a PKI architecture according to an embodiment of the present invention;

FIG. 3 is a signaling diagram showing a first phase of a PKI architecture creation according to one embodiment of the present invention;

FIG. 4 is a signaling diagram showing a second phase of a PKI architecture creation according to one embodiment of the present invention;

FIG. 5 is a signaling diagram showing a third phase of a PKI architecture creation according to one embodiment of the present invention;

FIG. 6 is a schematic illustration of a potential use case of embodiments of the present invention.

FIG. 7 is a perspective view of an electronic device that can be used in conjunction with the implementation of various embodiments of the present invention; and

FIG. 8 is a schematic representation of the circuitry which may be included in the electronic device of FIG. 7.

### DETAILED DESCRIPTION OF THE PREFERRED EMBODIMENTS

The present invention is described herein below with reference to the drawings representing particular non-limiting examples. A person skilled in the art will appreciate that the invention is not limited to these examples, and may be more broadly applied.

In particular, the present invention is described in relation to Universal Plug and Play (UPnP) standards. As such, the description of the embodiments given herein specifically refers to terminology which is directly related to UPnP. Such terminology is only used in the context of the presented examples, and does not limit the invention in any way. Rather, the present invention and its embodiments are likewise applicable to any other architecture/environment for peer-to-peer network connectivity. In other words, UpnP™ is used as an example only, and the present invention is applicable in its generality to a variety of similar or different systems.

Generally, for the purpose of the present invention to be described herein below, it should be noted that

a communication device or terminal may for example be any device by means of which a user may access a network and/or a server of such network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals (Universal Mobile Telecommunication System) are particularly suitable for being used in connection with the present invention, nevertheless terminals conforming to standards such as GSM (Global System for Mobile communications) or IS-95 (Interim Standard 95) may also be suitable;
networks referred to in this connection may comprise private media networks or public media networks, independent of the type of media kept in the network and the technology on which the networks are operated, for example those networks operate on the basis of the Internet Protocol IP, independent of the protocol version (IPv4 or IPv6), or on the basis of any other packet protocol such as User Datagram Protocol UDP, etc.
a communication device can act as a client entity or as a server entity in terms of the present invention, or may even have both functionalities integrated therein;
although reference was made herein before to media, this exemplifies only a specific example of “content” in general; content or media as used in the present invention is intended to mean at least one of audio data, video data, image data, text data, and metadata descriptive of attributes of the audio, video, image and/or text data, any combination thereof or even, alternatively or additionally, other data such as, as a further example, program code of an application program to be accessed/downloaded;
method processess likely to be implemented as software code portions and being run using a processor at one of the server/client entities are software code independent and can be specified using any known or future developed programming language as long as the functionality defined by the method processes is preserved;
method processes and/or devices likely to be implemented as hardware components at one of the server/client entities are hardware independent and can be implemented using any known or future developed hardware technology or any hybrids of these, such as MOS (Metal Oxide Semiconductor), CMOS (Complementary MOS), BiCMOS (Bipolar CMOS), ECL (Emitter Coupled Logic), TTL (Transistor Transistor Logic), etc., using for example ASIC (Application Specific Integrated Circuit) components or DSP (Digital Signal Processor) components, as an example;
generally, any method process is suitable to be implemented as software or by hardware without changing the idea of the present invention in terms of the functionality implemented;
devices can be implemented as individual devices, but this does not exclude that they are implemented in a distributed fashion throughout the system, as long as the functionality of the device is preserved; and
devices may also be implemented as a module configured to accomplish interoperability with other modules constituting an entire apparatus, e.g. a module device may be represented as a chipset or chip card e.g. insertable and/or connectable to an apparatus such as a mobile phone, or a module may be realized by executable code stored to a mobile phone or other device for execution upon invocation.

Various embodiments of the present invention provide a method and computer program product, embodied in a computer-readable medium, and registration authority for creating a generic public key infrastructure, involving establishing trust between a client and a registration authority and securely furnishing an enrolled certificate to the client by use of the established trust. The establishment of trust between the client and the registration authority can be based on public encryption keys of the client and the registration authority and based upon a UPnP security architecture. A public key can be used to indicate a certificate enrollment request from the client to the registration authority. The supply of the public key can indicate a certificate enrollment request is carried out during or after trust establishment. A certificate enrollment can be requested from the registration authority to a certificate authority. The certificate authority requested to sign a public key for generating a certificate can be selected by the registration authority based on protocols supported by the client. The requested certificate can be securely delivered from the registration authority to the client by use of the established trust. An authorization certificate containing a signature of the requested certificate can also be securely delivered. The authorization certificate can be signed by a private key of the registration authority. The registration authority can also comprise a security console according to a UPnP security architecture, and the client can comprise a device security function and a security-aware control point according to a UPnP security architecture. Various embodiments also address correspondingly configured servers and/or terminals, client and/or registration authority and/or certificate authority entities, as well as device security, security-aware control point and security console units, provided with such modules and functions enabling the aspects of the method/s to be carried out. For example, the present invention also addresses.

Various embodiments also provide a method, computer program product embodied in a computer-readable medium, and client apparatus for creating a generic public key infrastructure, being configured to establish trust with a registration authority and securely receive an enrolled certificate from the registration authority by use of the established trust. The client apparatus can be further being configured to establish the trust on basis of public encryption keys of the client and the registration authority. The trust can be established based on a UPNP security architecture. The client apparatus can be configured to supply a public key indicating a certificate enrollment request to the registration authority.

The public key indicating a certificate enrollment request can be supplied during or after trust establishment. An authorization certificate can be received containing a signature of the requested certificate. A device security function and a security-aware control point according to a universal plug and play, UPnP, security architecture can also be provided. Adapted units can perform the above-mentioned establishing, receiving, and supplying operations.

Various embodiments also provide a generic public key infrastructure architecture comprising a client apparatus including a device security unit and a security-aware control point unit, and a registration authority apparatus including a security console unit. The architecture can further comprise a certificate authority apparatus. The architecture and/or its constituents operate according to a UPnP security architecture.

Subsequently, the description will use UPnP™ networks as an example scenario. Expressions known from UPnP™ are used as non-respective examples, while, however, it should be kept in mind that this is only one example scenario in which the present invention is applicable.

In the following, an aspect of the present invention is explained, according to which a generic PKI architecture is created using an existing security association. As one example being described in detail below, a generic UPnP PKI architecture is created using existing UPnP security services.

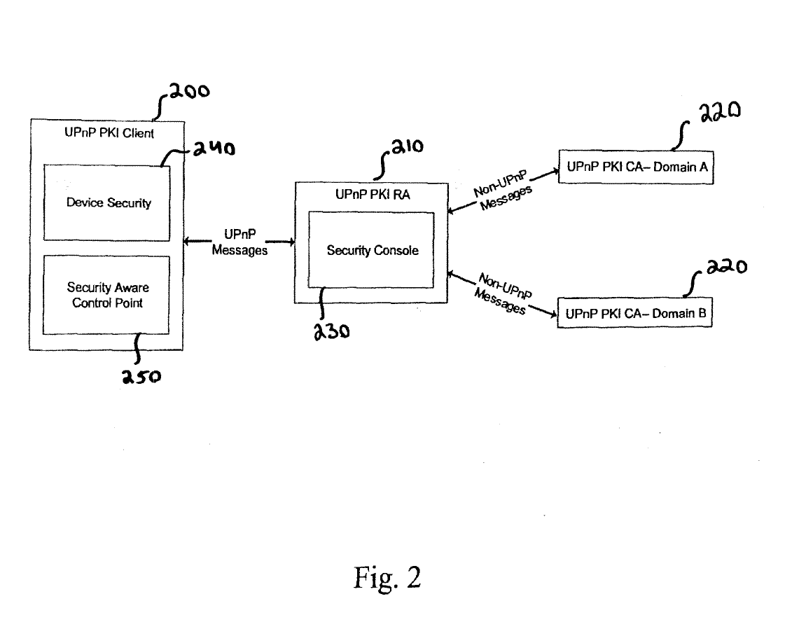

FIG. 2 is a schematic overview of a PKI architecture according to an embodiment of the present invention.

As shown in FIG. 2, a PKI system is exemplarily formed by a PKI client 200, a PKI registration authority (RA) 210 and two PKI certificate authorities (CA) 220, one for each domain served. Corresponding UPnP roles are assigned to the three kinds of PKI entities depicted. The PKI client 200, i.e. the user of certificates, comprises in UPnP terms a bundle of a device security function 240 and a security-aware control point (SA-CP) 250, i.e. a client control point. Thus, the PKI client 200 represents a security-aware UPnP device. The PKI registration authority 210, i.e. the interface between the PKI client 200 and one or more PKI certificate authorities 220, comprises in UPnP terms a security console 230. The PKI certificate authorities 220, i.e. the entity issuing a certificate, do not comprise any UPnP service or function. From a physical point of view, they can be co-located with the registration authority 210, with which it is associated, or it can be arranged separately, e.g. provided by a third party. Multiple certificate authorities can be associated with one registration authority 210, each serving a different domain (as indicated in FIG. 2 by “Domain A” and “Domain B”).

The communication between the client and the RA is 210 based on UPnP messages, and the communication between the RA 210 and the CA(s) 220 is based on non-UPnP messages, thus usually being proprietary.

By way of a special arrangement (mapping) of UPnP roles according to a UPnP security architecture and PKI entities (as exemplarily shown in FIG. 2), there is enabled a generic UPnP PKI architecture according to one embodiment of the present invention.

Basically, a creation of a generic public key infrastructure comprises establishing trust (i.e. a security association) between a client and a registration authority, and securely furnishing an enrolled certificate to the client by use of the established trust. The certificate furnishing basically includes a request for certificate enrollment from the client towards the registration/certificate authority and a delivery of a certificate from the certificate/registration authority to the client. Thereby, the validity of the certificate (or its destination) is authenticated by means of the established security association.

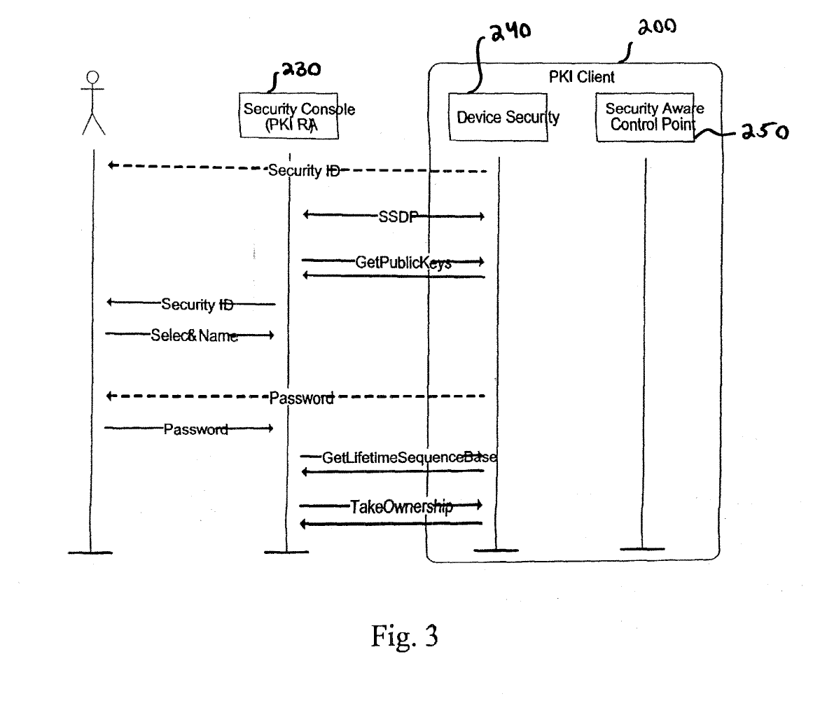

FIG. 3 is a signaling diagram showing a first phase of a PKI architecture creation according to one embodiment of the present invention, i.e. trust establishment. Using the rules of e.g. UPnP security, a registration authority device becomes a registered owner of a security-aware device, being denoted by PKI client 200. To this end, the registration authority discovers the client device by way of SSDP (simple service discovery protocol), finds the client's public key using e.g. a GetPublicKeys call and gets the nonce (using e.g. GetLifetimeSequenceBase), which it needs to make a valid TakeOwnership call on the client device. (“Nonce” being formed by “Number used ONCE” means an arbitrary number that is generated for security purposes such as an initialization vector. A nonce is used only one time in any security session.) This call is signed by the registration authority, so the client device can find out the public key of the security console 230 (i.e. the registration authority). The thus depicted trust establishment procedure essentially corresponds to a take ownership procedure. As such a take ownership procedure for trust establishment is known as such for a UPnP environment, no detail description thereof is provided hereinafter. Accordingly, the security console 230 of the PKI registration authority takes ownership of the PKI client 200 acting as a security-aware device. As described above, the take ownership operation is about securely getting a public key of the RA/SC to the secure device/PKI client 200. Thereafter, the PKI client 200 can make certificate requests for any domain it wishes and have trust in the response because it is authenticated with an RA public key. In detail, the device security function 240 of the PKI client 200 is involved in this process. That is, the trust establishment is based on UPnP security, which is also used as a transport mechanism for subsequent signing requests and certificate deliveries.

At the end of the signaling flow of FIG. 3, the PKI client 200 and the PKI RA (security console 230) have established mutual trust. Thus, on the basis of this trust (also referred to as security association or ownership), the security-aware device (PKI client 200) is in a position to start accepting certificates from the RA which have been issued by a certificate authority CA.

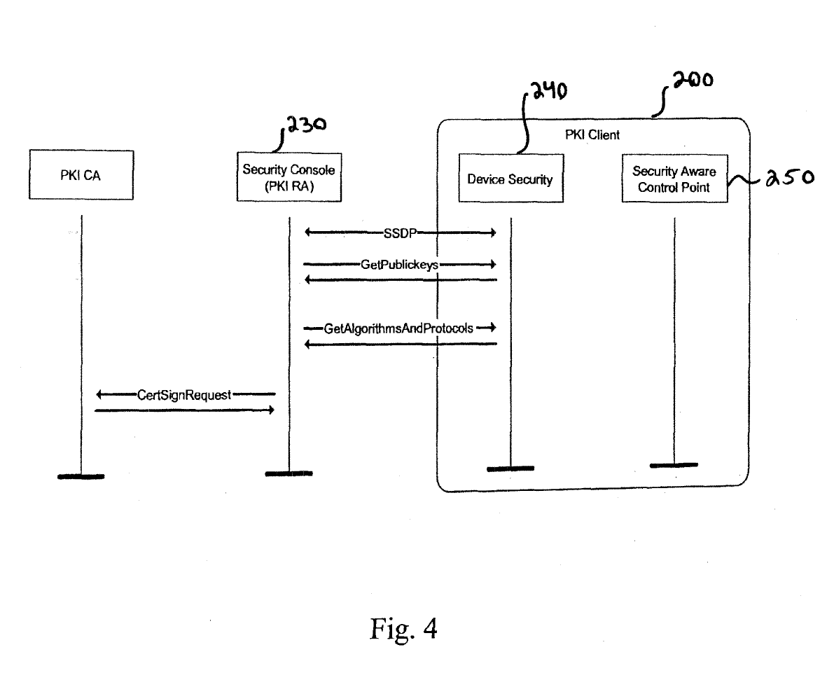

FIG. 4 is a signaling diagram showing a second phase of a PKI architecture creation according to one embodiment of the present invention, i.e. certificate enrollment. A certificate enrollment request is sent by the device security function 240 of the PKI client 200 to the security console 230 of the PKI registration authority. According to one embodiment of the present invention, this is effected by a public key indicating such an enrollment request.

The enrollment request in the form of a public key can either be fetched from the PKI client 200 by the PKI registration authority during a trust establishment process (e.g. take ownership procedure), e.g. as depicted in FIG. 3, or later on by invoking a further GetPublicKeys action by the PKI registration authority (i.e. owner of the PKI client device 200), e.g. as depicted in FIG. 4. That is, although described in connection with a separate diagram/phase, the enrollment request could also be performed as a response to the GetPublicKeys message in FIG. 3.

In FIG. 4, when the registration authority retrieves the set of public keys corresponding to private keys held by the client device (i.e. GetPublicKeys action), the PKI client 200 responds by returning its public keys. According to conventional UPnP security, the registration authority should expect to receive only one key in response. If the data structure returned as a response to the GetPublicKeys message contains more public keys than needed by UPnP security (e.g. more than one key as expected), this means that the device security function 240 is part of a PKI client device 200, i.e. that the security-aware UPnP device operates as a PKI client 200. The additional public key received from the client thus represents a certificate enrollment request. The PKI client 200 places this extra public key inside the response to a GetPublicKeys call in order to indicate its desire to participate in a PKI managed by the RA/Security Console 230, if possible.

UPnP security defines the key argument as a list containing public keys and their usage domains. For the above purpose of enrollment request transmittal, the key argument (<Keys>) of a response to a GetPublicKeys message according to UPnP security is adapted such that additional public keys and usages are contained. As can be gathered from an exemplary data structure listed below, previously only <Confidentiality> and <Signing> usages are defined for public keys. According to one embodiment of the present invention, an additional usage with associated public keys is introduced in this data structure (as is indicated below by being printed in bold and italics). Therein, <RemoteAccess> is only one example of an additional use case, and other examples could include IPSec tunnel creation, secure e-mail, secure communication for IM (Instant Messaging), gaming or VoIP (Voice over IP) or the like.

<Keys>

<Confidentiality>

<RSAKeyValue>

<Modulus>xA7SEU+e0y...</Modulus>
<Exponent>AQAB</Exponent>

</RSAKeyValue>

</Confidentiality>

<Signing>

<RSAKeyValue>

<Modulus>xA7SEU+e0y...</Modulus>
<Exponent>AQAB</Exponent>

</RSAKeyValue>

</Signing>

[symbol]

[symbol]

[symbol]

[symbol]

[symbol]

[symbol]

</Keys>

That is, a GetPublicKeys call response contains flexible extra fields as compared to current standards, which however also comply with the standardized syntax. When receiving such an extended data structure as the response to a GetPublicKeys call, the security console 230 of the PKI RA must expect a security-aware control point (SA-CP) 250 to be co-located in the same device as the device security unit or function 240. Such a security-aware control point 250 also uses the same security ID as the device security unit or function 240. The security console 230 of the PKI RA then must select and name the security-aware control point 250, although the SA-CP did not present any key, as usually required e.g. via a PresentKey action. (The same would also be the case, if the public key was fetched during the trust establishment phase, as mentioned above.)

Upon receipt of the public keys from the PKI client 200, the PKI RA detects which certificate authority (PKI CA) is competent for enrolling/signing the public key(s) received from the PKI client 200 (e.g. that for remote access purposes) and which parameters need to be added in a certificate enrollment/signing request. To this end, the registration authority retrieves a description of algorithms and protocols supported by the client device by sending a corresponding message according to UPnP security, i.e. a GetAlgorithmsAndProtocols message. Thereupon, the PKI client 200 (i.e. the device security unit or function 240 thereof) returns parameters including additional protocols for the intended purpose (e.g. remote access), where public keys are needed.

Based on the protocols received and the parameters thus needed, the PKI RA decides as to what kind of certificate is needed by the client, and as to which certificate authority is appropriate for issuance of such a certificate, i.e. signing the key(s) or enrolling the certificate. Corroborated with the information attached to the public keys, the registration authority thus generates a certificate request (certificate enrollment/signing request) and forwards it to the selected appropriate certificate authority (PKI CA). Following existing signing policies, the PKI CA signs/enrolls certificates and returns the enrolled/signed certificates to the PKI RA.

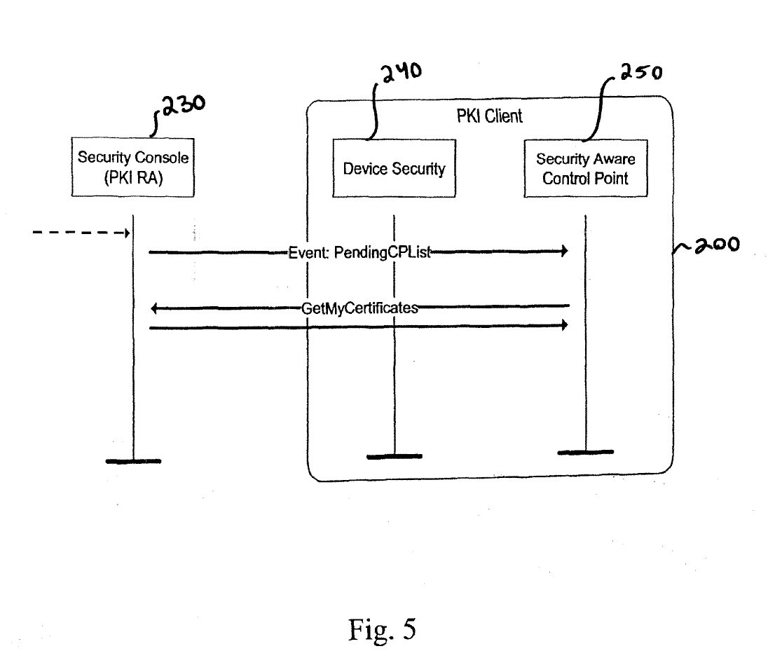

FIG. 5 is a signaling diagram showing a third phase of a PKI architecture creation according to one embodiment of the present invention, i.e. certificate delivery. When the security console 230 of the registration authority takes ownership of the PKI client 200 (in the take ownership phase, cf. above), the security-aware control point 250 (client control point) unit is enabled to subscribe for a pending control point list event on the owner's security console 230 (i.e. the registration authority). The subscription of a pending control point list event is for the subscribing control point to be added to a PendingCPList state variable of the security console 230, which gives a list of control points that have certificates waiting to be fetched.

When the security console 230 (registration authority) receives a certificate from the certificate authority (indicated in FIG. 5 by a dashed arrow from the left-hand side), the PendingCPList event is triggered at the security console 230 in order to inform the PKI client 200 that a certificate is waiting for it. Thereupon, the PKI client 200 (namely, the security-aware control point 250 thereof) fetches its certificate(s) by sending a GetMyCertificates message to the PKI RA. When the return argument on this message contains a certificate which is not compliant with UPnP security (i.e. a certificate for another purpose such as remote access, IPSec tunnel creation, etc.), the last certificate in the return argument sequence is an authorization certificate. This authorization certificate contains as elements the signature(s) of the non-UPnP security certificate(s). Stated in other words, a GetMyCertificates call according to the present embodiment contains an authenticated response, whereby the delivery of certificates is authenticated by the security console 230 of the PKI RA.

The authorization certificate is signed by the private key of the PKI RA security console 230, so preventing a potential man-in-the-middle attack. The PKI client 200 (namely the security-aware control point 250) receives the certificate(s) and verifies whether the respective signatures are the same as those included in the authorization certificate. If there is a match, the PKI client 200 is enabled to configure the protocols supported (as indicted in the second phase) with the appropriate certificates by passing the certificates to a corresponding protocol security engine. Accordingly, the PKI client 200 thus uses the security association (also referred to as trust or ownership) established during a previous (take ownership) operation in order to be sure that the certificate received really comes from an owner (i.e. security console 230 of PKI RA). Stated in other words, by way of a UPnP security association (trust), a certificate for some other purpose (e.g. remote access) is acquired/furnished. Thereby, a generic PKI architecture based on extended UPnP security is achieved by embodiments of the present invention.

In summary, according to the present aspect of the present invention, a generic solution of extended UPnP security is provided, which can be used in any situation where two (secure) devices need to agree on a certificate to be used for a specified purpose in communication between the two (secure) devices. That is, this approach can not only be used in setting up a remote access, but in more circumstances like any application or web service running on a secure device. Any such device can register its public key with a registration authority and be provisioned/furnished with a (enrolled)certificate in a secure manner. In the case of remote access for example, the certificate can be used by the PKI client 200 as a special root of trust certificate whereupon the application can restrict access to only those clients which have been approved and certified via its trusted registration authority. This is for example achieved by above-mentioned extra values, allowing to create enrollment requests where public keys are submitted along with an indication of the security domain where the issued certificate will be used.

The present aspect may thus be considered as a generic approach, for which various use cases are conceivable today and in the future. In this connection, as regards remote access as one exemplary use case, a home gateway (or media server) corresponds to a PKI client, and a home owner (or media server owner) corresponds to a PKI registration authority and a PKI certificate authority (where appropriate). A PKI certificate authority may be assumed to be co-located with a PKI registration authority, which implementation is also applicable in the present aspect, though not being necessary. Accordingly, a server device may be a client, a terminal may be a client or security-aware control point, and a home owner may be a registration and/or certificate authority.

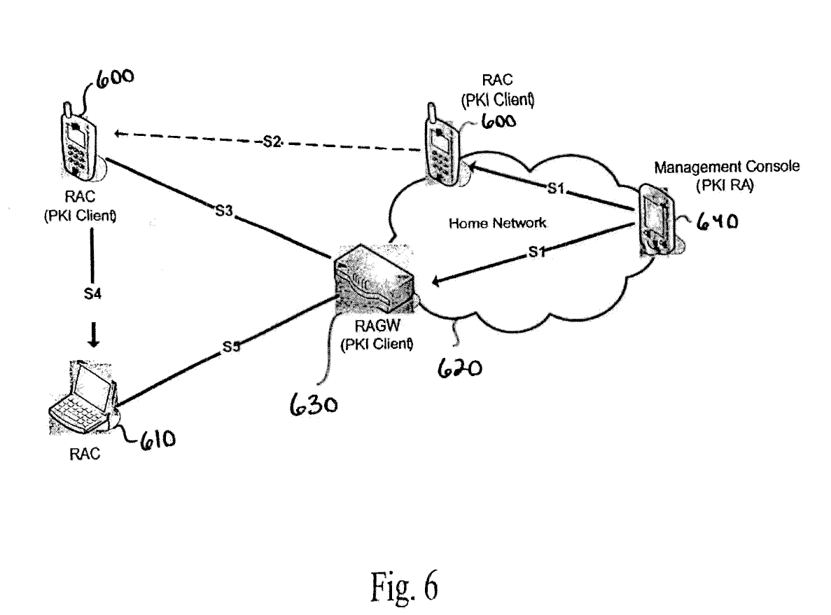

FIG. 6 is a schematic illustration of a potential use case of embodiments of the present invention, as described above. In FIG. 6, the numbering of processes indicates the sequence of events/operations.

For illustrative purposes, a management console in the exemplary form of a palm-top computer represents a public key registration authority (PKI RA), a remote access client (RAC) in the exemplary form of a mobile phone represents a public key client (PKI client), and a remote access gateway (RAGW) represents another public key client (PKI client). The management console, the remote access client and the remote access gateway are logically associated with the same communication infrastructure, being denoted by home network.

According to the exemplary use case depicted in FIG. 6, the management console 640 acting as PKI registration authority securely furnishes an enrolled certificate both to the remote access client and the remote access gateway, both acting as PKI clients, by use of an established trust within the home network 620 thereof (S1). This process is performed according to embodiments and aspects of the present invention as described above. The two certificate delivery operations may be performed (quasi) simultaneously or successively, as long as they are completed before any one of the subsequent processes. As the remote access client may be a mobile device, it may move out of its home network 620, which is illustrated by S2 in FIG. 6. In S3, the remote access client acting as PKI client 600 establishes a remote access connection with the remote access gateway 630 of its home network, which acts as a PKI client as well. Such a remote access may for example be applicable, when the remote access gateway constitutes a media server as mentioned above. The remote access connection according to the thus depicted use case is secured by certificates provisioned by way of the PKI infrastructure established pursuant to embodiments of the present invention.

In S4 of FIG. 6, a remote access client RAC 600, formerly acting as PKI client, may become a (subsidiary) certificate authority (sub-CA), thus being operable to issue certificates (in the PKI client) to other devices acting as a remote access client, such as for example the one in the exemplary form of a mobile computer in FIG. 6. The certificates can be delivered using near-field communication (NFC), smartcards or any other conceivable means. Hence, the other RAC device 610 is enabled to establish a remote access connection with the remote access gateway of the PKI client's home network 620 (S5). This connection is thus again secured by the certificates provisioned by way of the PKI infrastructure established pursuant to embodiments of the present invention.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

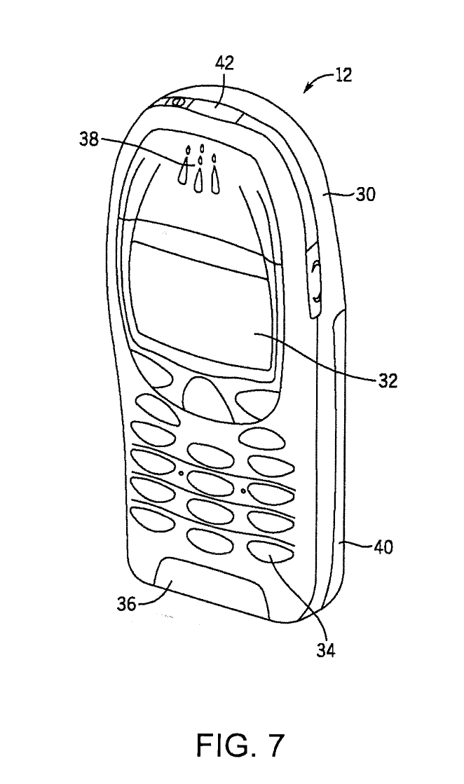

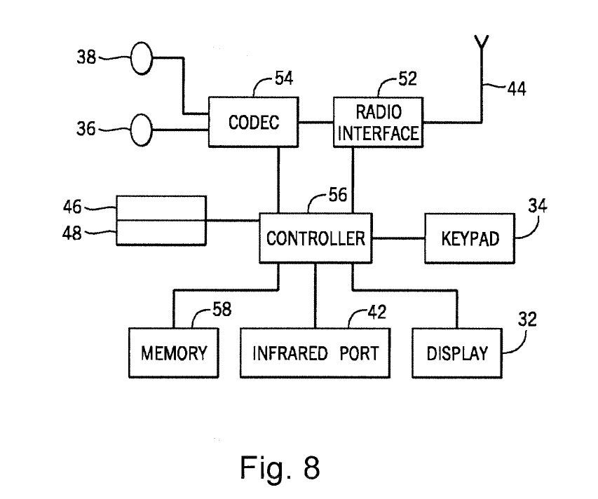

FIGS. 7 and 8 show one representative mobile device 12 within which the present invention may be implemented. It should be understood, however, that the present invention is not intended to be limited to one particular type of electronic device. The mobile device 12 of FIGS. 7 and 8 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type known in the art.

Although embodiments of the present invention are described above mainly with respect to the methods and operations performed, the present invention as a matter of course also covers respectively adapted and configured devices, modules, systems, computer programs and circuit arrangements for implementation of the described methods and operations in hardware and/or software.

The various embodiments may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

In general, it is to be noted that respective functional elements according to above-described embodiments can be implemented by any known means, either in hardware and/or software, respectively, if it is only adapted to perform the described functions of the respective parts. The mentioned method processes can be realized in individual functional blocks or by individual devices, or one or more of the method processes can be realized in a single functional block or by a single device.

Even though the invention is described above with reference to the examples according to the accompanying drawings, it is clear that the invention is not restricted thereto. Rather, it is apparent to those skilled in the art that the present invention can be modified in many ways without departing from the spirit and scope of the inventive idea as disclosed herein above.

Thus, in view of the forgoing, it becomes clear that the present invention addresses several aspects of methods, entities and modules, which are for example as follows:

What is claimed is:

1. A method of creating a generic public key infrastructure, comprising:
establishing trust between a client and a registration authority; and
securely furnishing an enrolled certificate to the client by use of the established trust.

2. The method of claim 1, wherein the establishment of trust between the client and the registration authority is based on public encryption keys of the client and the registration authority.

3. The method of claim 1, wherein the establishment of trust between the client and the registration authority is based on a universal plug and play (UPnP) security architecture.

4. The method of claim 1, further comprising supplying a public key indicating a certificate enrollment request from the client to the registration authority.

5. The method of claim 4, wherein the supply of the public key indicating a certificate enrollment request is carried out during or after trust establishment.

6. The method of claim 1, further comprising requesting certificate enrollment from the registration authority to a certificate authority.

7. The method of claim 6, wherein the certificate authority requested to sign a public key for generating a certificate is selected by the registration authority based on protocols supported by the client.

8. The method of claim 1, further comprising securely delivering the requested certificate from the registration authority to the client by use of the established trust.

9. The method of claim 1, further comprising securely delivering an authorization certificate containing a signature of the requested certificate.

10. The method of claim 9, wherein the authorization certificate is signed by a private key of the registration authority.

11. The method of claim 1, wherein the registration authority comprises a security console according to a universal plug and play (UPnP) security architecture.

12. The method of claim 1, wherein the client comprises a device security function and a security-aware control point according to a universal plug and play (UPnP) security architecture.

13. A client apparatus for creating a generic public key infrastructure, being configured to:
establish trust with a registration authority; and
securely receive an enrolled certificate from the registration authority by use of the established trust.

14. The client apparatus of claim 13, wherein the client apparatus is further configured to establish the trust on basis of public encryption keys of the client and the registration authority.

15. The client apparatus of claim 13, wherein the client apparatus is further configured to establish the trust on basis of a universal plug and play (UPnP) security architecture.

16. The client apparatus of claim 13, wherein the client apparatus is further configured to supply a public key indicating a certificate enrollment request to the registration authority.

17. The client apparatus of claim 16, wherein the client apparatus is further configured to supply the public key indicating a certificate enrollment request during or after trust establishment.

18. The client apparatus of claim 13, wherein the client apparatus is further configured to securely receive an authorization certificate containing a signature of the requested certificate.

19. The client apparatus of claim 13, comprising a device security mechanism and a security-aware control point according to a universal plug and play (UPnP) security architecture.

20. The client apparatus of claim 16, comprising at least one adapted unit configured to perform the establishing, receiving, and supplying operations.

21. A computer program, embodied in a computer-readable medium, comprising program code configured, when run on a processor of a client apparatus, to perform-establishing trust with a registration authority,
securely receiving an enrolled certificate from the registration authority by use of the established trust.

22. A generic public key infrastructure architecture, comprising:
a client apparatus including a device security unit and a security-aware control point unit; and
a registration authority apparatus comprising a security console unit at least in selective communication with the client apparatus.

23. The architecture of claim 22, further comprising a certificate authority apparatus in at least selective communication with the registration authority apparatus.

24. A registration authority apparatus for creating a generic public key infrastructure, the registration authority apparatus configured to:
establish trust with a client; and
securely furnish an enrolled certificate to the client by use of the established trust.

25. The registration authority apparatus of claim 24, wherein the registration authority apparatus is further configured to establish the trust on basis of public encryption keys of the client and the registration authority.

26. The registration authority apparatus of claim 24, wherein the registration authority is further configured to establish the trust on basis of a universal plug and play (UPnP) security architecture.

27. The registration authority apparatus of claim 24, wherein the registration authority is further configured to receive a public key supplied from the client, the public key indicating a certificate enrollment request.

28. The registration authority apparatus of claim 27, wherein the registration authority is further configured to receive the public key indicating a certificate enrollment request during or after trust establishment.

29. The registration authority apparatus of claim 24, wherein the registration authority is configured to request certificate enrollment from the registration authority to a certificate authority.

30. The registration authority apparatus of claim 29, wherein the registration authority is further configured to select a certificate authority to be requested to sign a public key for generating a certificate based on protocols supported by the client.

31. The registration authority apparatus of claim 24, wherein the registration authority is further configured to: securely deliver the requested certificate from the registration authority to the client by use of the established trust.

32. The registration authority apparatus of claim 24, wherein the registration authority is further configured to: securely deliver an authorization certificate containing a signature of the requested certificate.

33. The registration authority apparatus of claim 32, wherein the registration authority is further configured to sign the authorization certificate by a private key of the registration authority.

34. The registration authority apparatus of claim 24, comprising a security console according to a universal plug and play (UPnP) security architecture.

35. A computer program, embodied in a computer-readable medium, comprising program code configured, when run on a processor of a registration authority, to perform
establishing trust with a client,
securely furnishing an enrolled certificate to the client by use of the established trust.
